(19) United States
(12) Patent Application Publication
(10) Pub. No.: US 2025/0112387 A1
(43) Pub. Date: Apr. 3, 2025

(54) ELECTRICAL ASSEMBLY

(71) Applicant: Lear Corporation, Southfield, MI (US)

(72) Inventors: Jordi Angel Serrano, Remscheid (DE); Michal Brhel, Sardice (CZ); Yasin Canol, Remscheid (DE); Xavier Farre Vives, Valls (ES); Uemit Celiker, Remscheid (DE)

(73) Assignee: Lear Corporation, Southfield, MI (US)

(21) Appl. No.: 18/897,782

(22) Filed: Sep. 26, 2024

Related U.S. Application Data
(60) Provisional application No. 63/587,326, filed on Oct. 2, 2023.

(51) Int. Cl. H01R 12/70; B60R 16/023; H01R 4/34; H01R 13/04

(52) U.S. Cl. CPC H01R 12/7076; B60R 16/0239; H01R 4/34; H01R 13/04; H01R 2201/26

(57) ABSTRACT

An electrical assembly comprises a housing defining a housing interior, and an electrical terminal. The electrical terminal can include a first terminal portion disposed in the housing interior, and a second terminal portion disposed outside of the housing interior and including an eyelet. The housing can be overmolded on the electrical terminal.

### CROSS-REFERENCE TO RELATED APPLICATIONS

This application claims the benefit of and priority to U.S. Provisional Application 63/587,326 filed Oct. 2, 2023, the disclosure of which is hereby incorporated by reference in its entirety as though fully set forth herein.

### TECHNICAL FIELD

The present disclosure generally relates to electrical assemblies, including electrical assemblies that can, for example, be utilized in connection with vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of an electrical assembly according to teachings of the present disclosure.

FIG. 2 is a perspective view generally illustrating an embodiment of an electrical terminal according to teachings of the present disclosure.

FIG. 3 is a partial perspective view generally illustrating an embodiment of an electrical assembly connected to a chassis, with the chassis shown as partially transparent, according to teachings of the present disclosure.

FIG. 4 is a partial cross-sectional perspective view generally illustrating an embodiment of an electrical assembly connected to a chassis, with the chassis shown as partially transparent, according to teachings of the present disclosure.

FIG. 5 is a perspective view generally illustrating an embodiment of an electrical terminal according to teachings of the present disclosure.

FIG. 6 is a schematic view generally illustrating an embodiment of an electrical assembly comprising two electrical connectors according to teachings of the present disclosure.

FIG. 7 is a schematic view generally illustrating an embodiment of an electrical assembly comprising two circuit boards according to teachings of the present disclosure.

FIG. 8 is a top view generally illustrating an embodiment of a sheet of material for forming electrical terminals according to teachings of the present disclosure.

FIG. 9 is a flow diagram view generally illustrating an embodiment of a method of assembling a vehicle according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

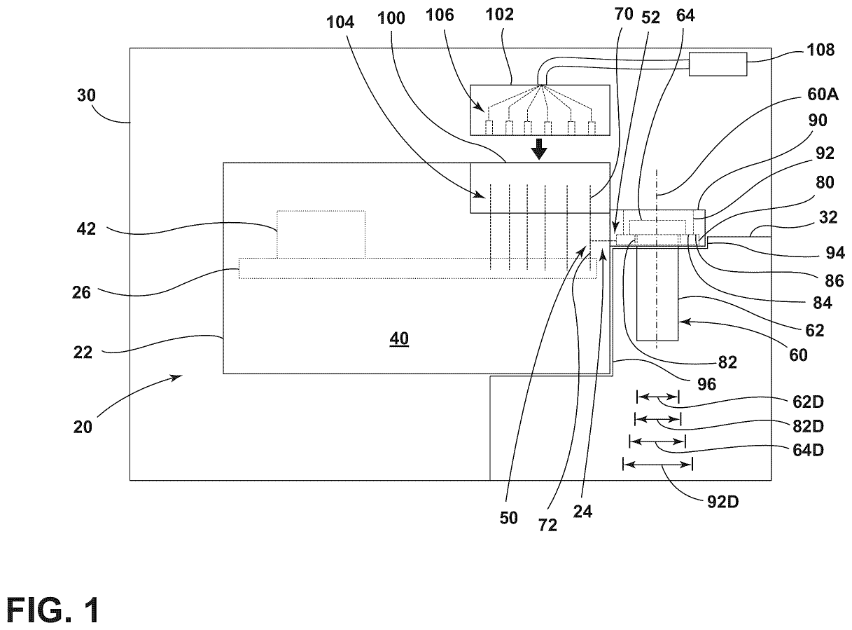

Referring to FIG. 1, an electrical assembly 20 includes a housing 22, an electrical terminal 24, and a circuit board 26. The electrical assembly 20 is mounted to a chassis 32 of a vehicle 30, but can be mounted to other mounting surfaces. The housing 22 defines a housing interior 40. The circuit board 26 and one or more electrical components 42 (e.g., relays, fuses, capacitors, resistors, inductors, controllers, among others) can be disposed in the housing interior 40. The one or more electrical components 42 can be connected to (e.g., mounted to) the circuit board 26.

The electrical terminal 24 includes a first terminal portion 50 and a second terminal portion 52. The first terminal portion 50 is disposed in the housing interior 40, and the second terminal portion 52 is disposed at least partially outside the housing interior 40, such as to electrically and/or mechanically connect the electrical assembly 20 to the chassis 32. The first terminal portion 50 can be electrically connected (e.g., soldered) to another component, such as the circuit board 26. The second terminal portion 52 is connected to the chassis 32 via a fastener 60, such as a bolt. The fastener 60 includes a body 62 and a head 64 disposed at an end of the body 62 and having a diameter 64D that is larger than the diameter 62D of the body 62.

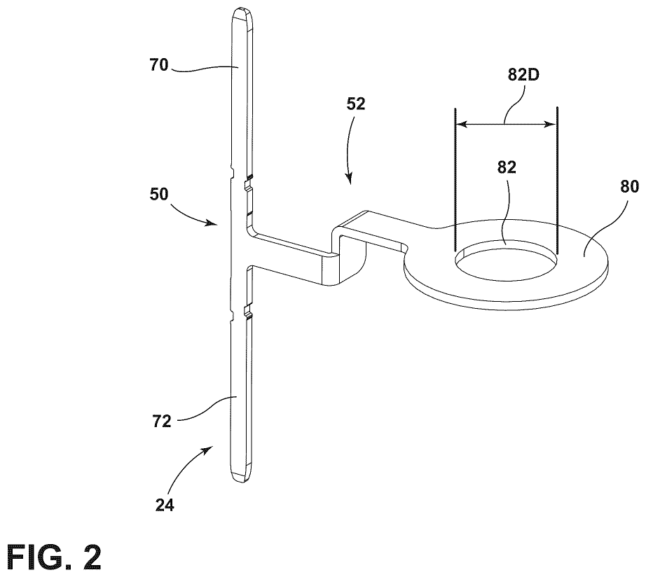

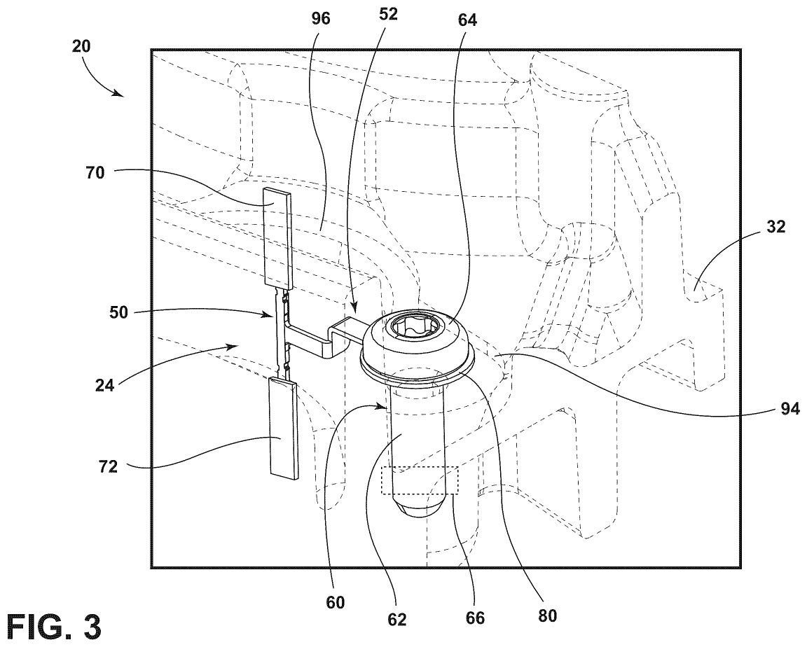

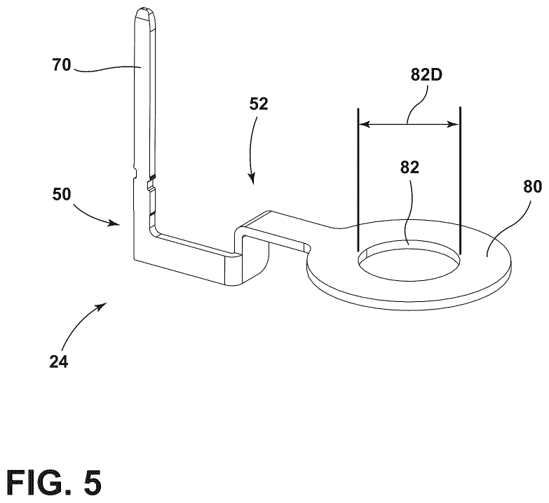

Referring to FIG. 2, the first terminal portion 50 of the electrical terminal 24 includes a first pin or receptacle 70 and/or a second pin or receptacle 72. Optionally, in some configurations, the first pin or receptacle 70 is configured as a pin and the second pin or receptacle 72 is configured as a pin. In other configurations, the first pin or receptacle 70 is configured as a receptacle (e.g., configured to at least partially receive another terminal, such as a pin terminal) and the second pin or receptacle 72 is configured as a receptacle (see, e.g., FIG. 3). In yet other configurations, one of the first pin or receptacle 70 or the second pin or receptacle 72 is configured as a pin and the other of the first pin or receptacle 70 or the second pin or receptacle 72 is configured as a receptacle. The first pin or receptacle 70 extends in the first direction and the second pin or receptacle 72 extends in a second direction that can be opposite the first direction. While the electrical terminal 24 is illustrated with two pins or receptacles 70, 72, the electrical terminal 24 can include other numbers of pins or receptacles, such as one pin or receptacle 70 (FIG. 5) or more than two pins or receptacles. The pins can include pins, blades, other configurations, or combinations thereof.

The second terminal portion 52 includes an eyelet 80 that defines an aperture 82. The eyelet 80 is perpendicular to the first pin or receptacle 70 and the second pin or receptacle 72. Optionally, the eyelet 80 is disposed at a different angle or is parallel to the first pin or receptacle 70 and/or the second pin or receptacle 72. The aperture 82 has a diameter 82D, which is at least as large as the diameter 62D of the body 62 (FIG. 1) and smaller than the diameter 64D of the head 64 of the fastener 60 (FIG. 1). The first pin or receptacle 70 and the second pin or receptacle 72 can be parallel to a centerline 60A of the fastener 60 (FIG. 1). The eyelet 80 is continuous in the circumferential direction such that the aperture 82 is closed, but the eyelet 80 can have other configurations, such as configurations with a circumferential gap.

Referring to FIG. 3, the body 62 of the fastener 60 is disposed partially in and extends through eyelet 80 (e.g., through the aperture 82—see FIG. 1), and the head 64 is disposed directly on the eyelet 80, such as without a bushing or washer. Optionally, a bushing and/or a washer is disposed between the head 64 and the eyelet 80. The body 62 extends through the eyelet 80 and into the chassis 32, such as to mechanically and electrically connect the electrical assembly 20 to the chassis 32. For example, the body 62 can be threaded into the chassis 32 and/or the fastener 60 can comprise a nut 66 threaded onto the body 62 such that at least portions of the eyelet 80 and the chassis 32 are disposed between the head 64 and the nut. The electrical connection electrically grounds the electrical assembly 20 and/or one or more components electrically connected thereto, such as the components 42 (FIG. 1), to the chassis 32.

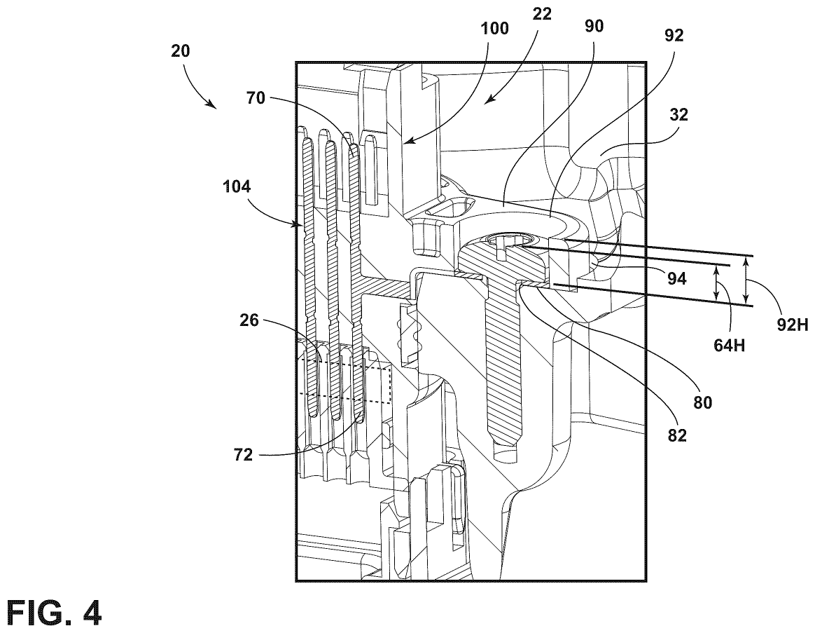

Referring to FIG. 4, the housing 22 includes a mounting flange 90 defining a housing aperture 92. The mounting flange 90 extends outward from the housing 22, is parallel with the eyelet 80, and partially covers second terminal portion 52, such as a portion of the eyelet 80. For example, the eyelet 80 can include an exposed portion 84 (FIG. 1) that is not covered by the mounting flange 90 and a covered portion 86 (FIG. 1) that is covered by the mounting flange 90. The housing aperture 92 is aligned with the aperture 82 of the eyelet 80 such that the mounting flange 90 does not cover the aperture 82. A height 92H of the housing aperture 92 is greater than a height 64H of the head 64 of the fastener 60 such that the head 64 is recessed in the mounting flange 90. The housing aperture 92 has a diameter 92D that is larger than the diameter 64D of the head 64. The chassis 32 can include a recess 94 that at least partially receives the eyelet 80 and/or the mounting flange 90. Additionally or alternatively, the chassis 32 can include a recess 96 (FIG. 1) that at least partially receives the housing 22, such as portions other than the mounting flange 90.

The housing 22 includes an electrical connector receptacle 100 configured to at least partially receive and connect to an electrical connector 102 (e.g., a first electrical connector), which may include one or more connector pins 106 and/or may be connected to one or more other components or systems 108 (see e.g., FIG. 1), such as vehicle components or systems. The first pin or receptacle 70 of the electrical terminal 24 extends into and is disposed partially in the electrical connector receptacle 100. The electrical assembly 20 can include one or more housing pins 104 that are disposed at least partially in the electrical connector receptacle 100. The one or more housing pins 104 can, for example and without limitation, include at least five housing pins 104. The second pin or receptacle 72 and/or lower portions of the one or more housing pins 104 can extend toward, into, and/or through the circuit board 26. The electrical connector 102 can be at least partially external to the electrical assembly 20 and/or the housing 22 (e.g., formed separately from) and may be referred to as an external electrical connector.

Referring to FIG. 5, the electrical terminal 24 can include a single pin or receptacle 70.

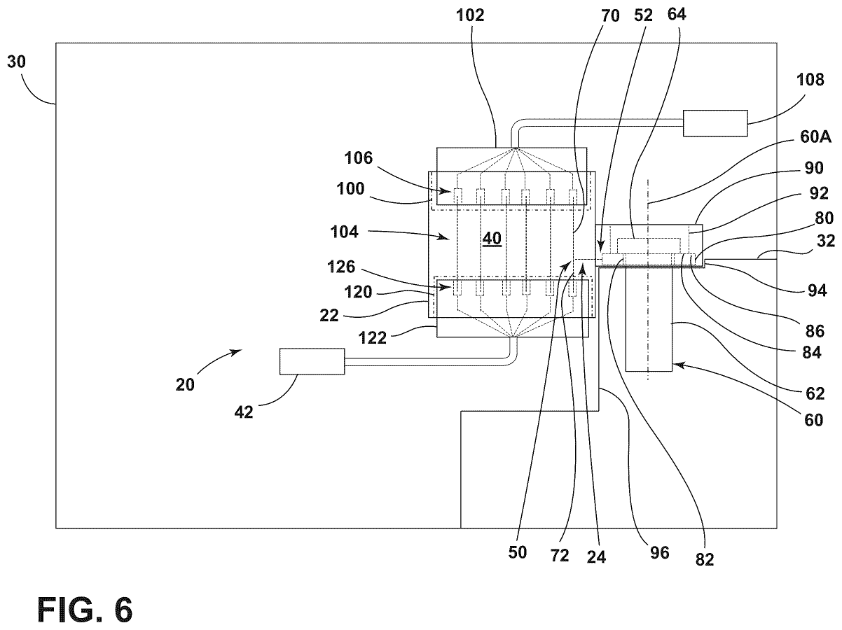

Referring to FIG. 6, the housing 22 optionally includes the electrical connector receptacle 100 (e.g., a first connector receptacle) and a second connector receptacle 120. The second connector receptacle 120 is, for example, provided instead of the circuit board 26. The second connector receptacle 120 is configured to at least partially receive a second electrical connector 122. The second electrical connector 122 is, for example, electrically connected with the electrical components 42. The second electrical connector 122 includes a plurality connector pins 126 that electrically connect with the housing pins 104 and the electrical terminal 24, such as at opposite ends from the connector pins 106 of the electrical connector 102. In the illustrated example, the second connector receptacle 120 and the second electrical connector 122 are disposed in a mirrored configuration relative to the electrical connector receptacle 100 and the electrical connector 102, with the electrical connector 102 connected to the electrical connector receptacle 100 at the top of the housing 22 and the second electrical connector 122 connected to the second connector receptacle 120 at a bottom of the housing 22.

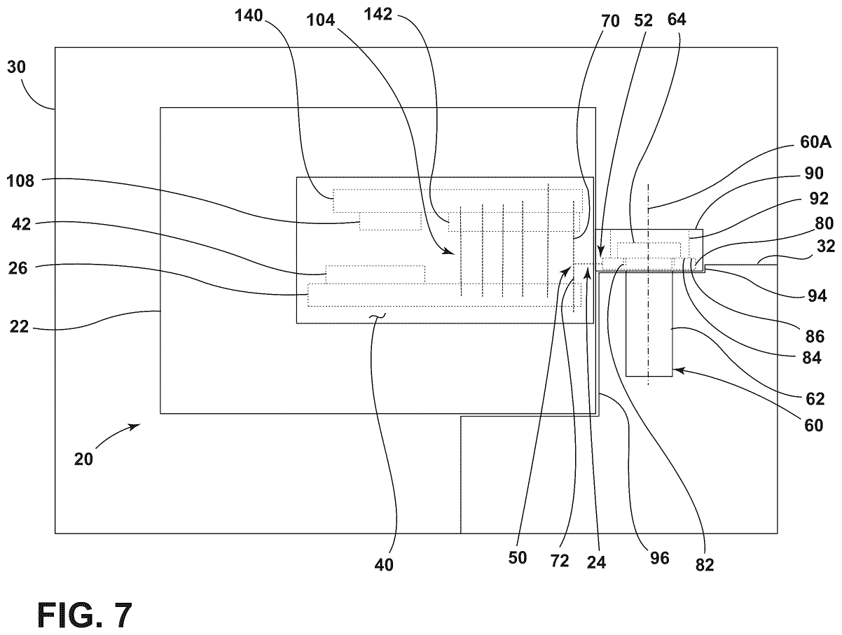

Referring to FIG. 7, the electrical assembly 20 optionally includes the circuit board 26 (e.g., a first circuit board) and a second circuit board 140. The circuit boards 26, 140 are illustrated entirely inside the housing 22, but can be disposed in other configurations, such either or both be disposed partially inside the housing 22 or entirely outside the housing 22. The second circuit board is, for example, provided instead of the electrical connector 102. The second circuit board 140 is electrically connected with the housing pins 104 and the electrical terminal 24, such as opposite ends from the circuit board 26. In the illustrated example, the circuit board 26 and the second circuit board 140 in a mirrored configuration with the circuit board 26 electrically connected to bottom ends of the housing pins 104 and the electrical terminal 24, and with the second circuit board 140 electrically connected to top ends of the housing pins 104 and the electrical terminal 24. Optionally, the circuit board 26 and/or the second circuit board 140 includes a header 142 connected thereto to facilitate electrical connection with the housing pins 104 and the electrical terminal 24. Optionally, at least some of the one or more other components or systems 108 are electrically connected to the second circuit board 140.

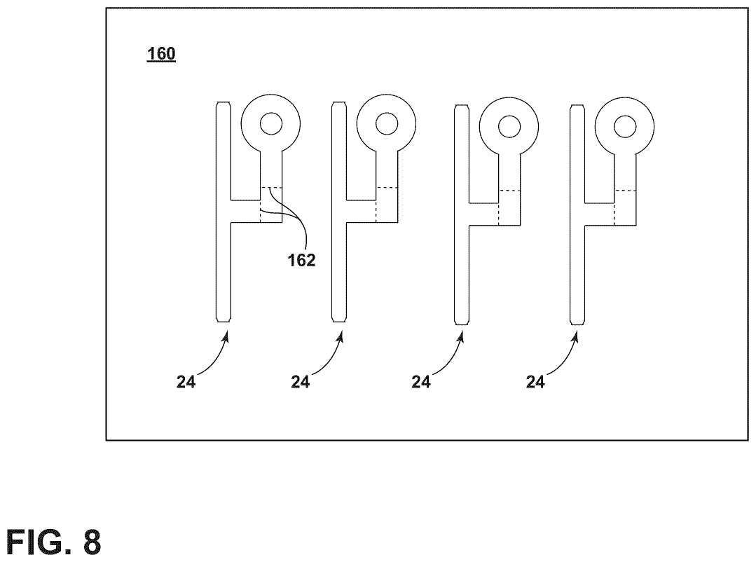

Referring to FIG. 8, the electrical terminal 24 can be stamped from a sheet of material 160, such as metal. A plurality of electrical terminals 24 can be stamped at the same time from the same sheet of material 160. The electrical terminal 24 can be bent after stamping, such as at one or more bend lines or regions 162.

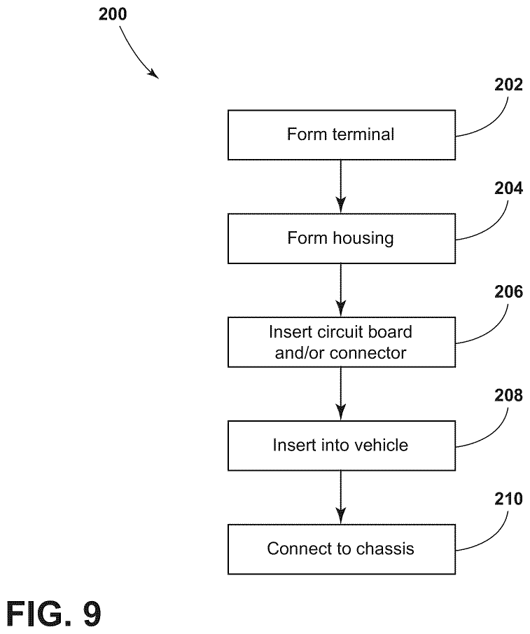

Referring to FIG. 9, a method 200 of assembling an electrical assembly 20 and/or assembling a vehicle 30 can include forming the electrical terminal 24 (block 202). Forming the electrical terminal 24 (block 202) can include stamping one or more electrical terminal 24 from a sheet of material 160 and/or bending one or more sections of the electrical terminal 24, such as at the one or more bend lines or regions 162. The electrical terminal 24 can be initially formed as a single, unitary, monolithic component.

The method 200 can include forming the housing 22 (block 204), such as via overmolding the housing 22 onto the electrical terminal 24 after the electrical terminal 24 is formed in block 202. Optionally, the housing 22 is overmolded onto the electrical terminal 24 and one or more of the housing pins 104. The method 200 can include disposing the circuit board 26, one or more electrical connectors 102, 122 and/or one or more electrical components 42 at least partially into the housing interior 40 (block 206), such as to form the electrical assembly 20. Block 206 optionally includes inserting at least one of the circuit board 26 or the electrical connector 102 into the housing 22 such that the at least one of the circuit board 26 or the electrical connector 102 are electrically connected with the electrical terminal 24 and one or more of the housing pins 104. For example, block 206 optionally includes inserting the circuit board 26 and the electrical connector 102 at least partially into the housing 22. Additionally or alternatively, block 206 includes inserting the circuit board 26 and the second circuit board 140 at least partially into the housing 22. Additionally or alternatively, block 206 includes inserting the electrical connector 102 and the second electrical connector 122 at least partially into the housing 22.

The method 200 can include disposing the electrical assembly 20 in the vehicle 30 (block 208). The method 200 can include connecting the electrical assembly 20 with a mounting surface, such as the chassis 32 of the vehicle 30 (block 210), which may include inserting the fastener 60 into the eyelet 80 and the chassis 32. Inserting the fastener 60 into the eyelet 80 and the chassis 32 can (i) mechanically connect the electrical assembly 20 with the chassis, and (ii) electrically connect (e.g., electrically ground) the electrical assembly 20, and/or one or more components at least indirectly electrically connected thereto, such as the electrical components 42 and/or the electrical connector 102, with the chassis 32. The method 200 may not include crimping the electrical terminal 24, such as with a wire or cable. The method 200 may include not utilizing separate fasteners to connect the electrical terminal 24 to the housing 22, and/or not utilizing washers or bushings to connect the electrical terminal 24 to the chassis 32, which can simplify assembly.

While described in connection with a vehicle 30 and a chassis 32, embodiments of the electrical assembly 20 can be utilized in other, non-vehicle applications. For example, the electrical assembly 20 can be mounted to a mounting surface that is not a vehicle chassis.

The instant disclosure includes the following non-limiting embodiments:

An electrical assembly, comprising: a housing defining a housing interior; and
an electrical terminal including: a first terminal portion disposed in the housing interior, and a second terminal portion disposed outside of the housing interior and including an eyelet.

The electrical assembly of any preceding embodiment, further comprising at least one of a first circuit board or a first electrical connector disposed at least partially in the housing and electrically connected with the first terminal portion.

The electrical assembly of any preceding embodiment, wherein the housing is overmolded on the electrical terminal.

The electrical assembly of any preceding embodiment, wherein the eyelet includes an exposed portion not covered by the housing.

The electrical assembly of any preceding embodiment, wherein the first terminal portion includes a first pin.

The electrical assembly of any preceding embodiment wherein the first terminal portion includes a second pin.

The electrical assembly of any preceding embodiment, wherein the first terminal portion includes a first pin and a second pin.

The electrical assembly of any preceding embodiment, further comprising a first electrical connector disposed at least partially in the housing; wherein the housing includes a connector receptacle configured for mating with the first electrical connector; and the first pin is disposed at least partially in the connector receptacle.

The electrical assembly of any preceding embodiment, further comprising at least five housing pins disposed at least partially in the connector receptacle.

The electrical assembly of any preceding embodiment, further comprising a first circuit board disposed at least partially in the housing; wherein the second pin is electrically connected to the first circuit board.

The electrical assembly of any preceding embodiment, wherein housing includes a second connector receptacle; and the second pin is disposed at least partially in the second connector receptacle.

The electrical assembly of any preceding embodiment, wherein the eyelet is perpendicular to the first pin and the second pin.

The electrical assembly of any preceding embodiment, further comprising a fastener disposed partially in the eyelet; wherein the first pin and the second pin are parallel to a centerline of the fastener.

The electrical assembly of any preceding embodiment, further comprising a first circuit board and a second circuit board disposed at least partially in the housing; wherein the first terminal portion is electrically connected with the first circuit board and the second circuit board.

The electrical assembly of any preceding embodiment, wherein the first terminal portion includes a first terminal receptacle.

The electrical assembly of any preceding embodiment, wherein the first terminal portion includes a second terminal receptacle.

The electrical assembly of any preceding embodiment, wherein the first terminal portion includes a first terminal receptacle and a second terminal receptacle.

The electrical assembly of any preceding embodiment, wherein the housing partially covers the eyelet.

The electrical assembly of any preceding embodiment, wherein the eyelet includes an eyelet aperture; and the housing includes a housing aperture aligned with the eyelet aperture such that the housing does not cover the eyelet aperture.

The electrical assembly of any preceding embodiment, further comprising a fastener including a body and a head; wherein a diameter of the housing aperture is larger than a diameter of the head; and the diameter of the head is larger than the diameter of the eyelet aperture.

The electrical assembly of any preceding embodiment, wherein a height of the housing aperture is greater than a height of the head.

A vehicle, comprising: the electrical assembly of any preceding embodiment; a chassis; and a fastener; wherein the electrical assembly is fixed to the chassis via the fastener and the electrical terminal; and the electrical assembly is electrically connected to the chassis via the fastener and the electrical terminal.

The vehicle of any preceding embodiment, wherein the fastener is in direct contact with the eyelet and the chassis.

The vehicle of any preceding embodiment, wherein the eyelet is in direct contact with the chassis and the fastener.

A method of assembling the vehicle of any preceding embodiment, the method comprising: forming the electrical terminal; overmolding the housing on the electrical terminal; and inserting the fastener into the eyelet and the chassis to (i) mechanically connect the electrical assembly with the chassis, and (ii) electrically ground the electrical assembly with the chassis.

The method of any preceding embodiment, wherein forming the electrical terminal includes stamping.

The method of any preceding embodiment, wherein the stamping includes stamping the first terminal portion and the second terminal portion.

The method of any preceding embodiment, wherein forming the electrical terminal includes bending the second terminal portion relative to the first terminal portion.

A vehicle comprising the electrical assembly of any preceding embodiment.

An electronic controller configured to implement the method of any preceding embodiment.

A vehicle comprising the electronic controller of any preceding embodiment.

A non-transitory computer-readable storage medium having a computer program encoded thereon for implementing the method of any preceding embodiment.

A vehicle comprising the non-transitory computer-readable storage medium of any preceding embodiment.

In examples, a controller may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “in the illustrated example,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in the illustrated example,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

References to a vehicle can include one or more of a variety of vehicles, including, without limitation, a passenger car (e.g., a sedan, a pickup truck, a sport utility vehicle, a crossover, etc.), a truck, a bus, a plane, or a boat, among others.

All matter contained in the above description or shown in the accompanying drawings shall be interpreted as illustrative only and not limiting. Changes in detail or structure may be made without departing from the present disclosure.

What is claimed is:

1. An electrical assembly, comprising:
a housing defining a housing interior; and
an electrical terminal including:
a first terminal portion disposed in the housing interior, and
a second terminal portion disposed outside of the housing interior and including an eyelet.

2. The electrical assembly of claim 1, further comprising at least one of a first circuit board or a first electrical connector disposed at least partially in the housing and electrically connected with the first terminal portion.

3. The electrical assembly of claim 1, wherein the housing is overmolded on the electrical terminal.

4. The electrical assembly of claim 3, wherein the second terminal portion includes an exposed portion not covered by the housing.

5. The electrical assembly of claim 1, wherein the first terminal portion includes a first pin and a second pin.

6. The electrical assembly of claim 5, further comprising a first electrical connector disposed at least partially in the housing;
wherein the housing includes a connector receptacle configured for mating with the first electrical connector; and
the first pin is disposed at least partially in the connector receptacle.

7. The electrical assembly of claim 6, further comprising at least five housing pins disposed at least partially in the connector receptacle.

8. The electrical assembly of claim 6, further comprising a first circuit board disposed at least partially in the housing;
wherein the second pin is electrically connected to the first circuit board.

9. The electrical assembly of claim 6, wherein the housing includes a second connector receptacle; and
the second pin is disposed at least partially in the second connector receptacle.

10. The electrical assembly of claim 5, wherein the eyelet is perpendicular to the first pin and the second pin.

11. The electrical assembly of claim 5, further comprising a fastener disposed partially in the eyelet;
wherein the first pin and the second pin are parallel to a centerline of the fastener.

12. The electrical assembly of claim 1, further comprising a first circuit board and a second circuit board disposed at least partially in the housing;
wherein the first terminal portion is electrically connected with the first circuit board and the second circuit board.

13. The electrical assembly of claim 1, wherein the first terminal portion includes a first terminal receptacle; and
the first terminal portion includes a second terminal receptacle.

14. The electrical assembly of claim 1, wherein the housing partially covers the eyelet.

15. The electrical assembly of claim 1, wherein the eyelet includes an eyelet aperture; and
the housing includes a housing aperture aligned with the eyelet aperture such that the housing does not cover the eyelet aperture.

16. The electrical assembly of claim 15, further comprising a fastener including a body and a head;
wherein a diameter of the housing aperture is larger than a diameter of the head; and
the diameter of the head is larger than the diameter of the eyelet aperture.

17. The electrical assembly of claim 16, wherein a height of the housing aperture is greater than a height of the head.

18. A vehicle, comprising:
the electrical assembly of claim 1;
a chassis; and
a fastener;
wherein the electrical assembly is fixed to the chassis via the fastener and the electrical terminal; and
the electrical assembly is electrically connected to the chassis via the fastener and the electrical terminal.

19. The vehicle of claim 18, wherein the fastener is in direct contact with the eyelet and the chassis.

20. The vehicle of claim 18, wherein the eyelet is in direct contact with the chassis and the fastener.
